(19) United States
(12) Patent Application Publication
(10) Pub. No.: US 2024/0131657 A1
(43) Pub. Date: Apr. 25, 2024

(54) CLAMPING UNIT AND CLAMPING SYSTEM

(71) Applicant: THK CO., LTD., Tokyo (JP)

(72) Inventor: Yoshinobu YAMABE, Tokyo (JP)

(73) Assignee: THK CO., LTD., Tokyo (JP)

(21) Appl. No.: 18/378,362

(22) Filed: Oct. 9, 2023

(30) Foreign Application Priority Data
Oct. 18, 2022 (JP) 2022-167770

(51) Int. Cl. B25B 5/06

(52) U.S. Cl. CPC B25B 5/061

(57) ABSTRACT

A clamping unit includes a clamping mechanism that takes a clamping state when a pressure in a pressure-acting chamber defined in a case is equal to or less than a predetermined threshold value, and takes an unclamping state when the pressure in the pressure-acting chamber is larger than the predetermined threshold value. The case of the clamping unit has a first outer side surface and a second outer side surface that are provided with a first opening portion and a second opening portion, respectively, which are in communication with each other through a supply and discharge port via the pressure-acting chamber.

### STATEMENT REGARDING PRIOR DISCLOSURES BY THE INVENTOR OR A JOINT INVENTOR UNDER 37 C.F.R. 1.77(B)(6)

A part of the invention according to the Japanese Patent Application No. 2022-167770 was published by the inventor of the Japanese Patent Application No. 2022-167770 at the 7th Manufacturing World Nagoya held Apr. 13-15, 2022 and the 34th Manufacturing World Japan held Jun. 22-24, 2022. The inventor of the Japanese Patent Application No. 2022-167770 is Yoshinobu YAMABE who is the inventor of the present application. The applicant, THK CO. LTD., of the Japanese Patent Application No. 2022-167770 is an assignee who obtained the invention of the Japanese Patent Application from the present inventor.

### CROSS REFERENCE TO THE RELATED APPLICATION

This application claims the benefit of Japanese Patent Application No. 2022-167770, filed on Oct. 19, 2022, which is hereby incorporated by reference herein in its entirety.

### BACKGROUND

### Technical Field

The present invention relates to a clamping unit and a clamping system.

### Description of the Related Art

In a copying or profiling device or the like used for holding a work or the like, there may be used a clamping unit that can switch between a clamping state in which the relative movement of a shaft member with a contactor or the like attached thereto is allowed and an unclamping state in which the relative movement of the shaft member is restricted.

As the clamping unit, there has been known, for example, a combination of a first clamping mechanism that can restrict the relative movement of the shaft member in a first direction in the axial direction thereof, and a second clamping mechanism that can restrict the relative movement of the shaft member in a second direction opposite to the first direction in the axial direction (for example, see Patent Literature 1).

The first clamping mechanism and the second clamping mechanism are each provided with: an outer cylinder that is a cylindrical member into which the shaft member is inserted, the outer cylinder being formed with a tapered surface on an inner peripheral surface thereof surrounding an outer peripheral surface of the shaft member; an inner cylinder arranged inside the outer cylinder; a plurality of rolling elements held in the inner cylinder; and an urging member configured to urge the rolling elements from a larger diameter side to a smaller diameter side of the tapered surface through the inner cylinder.

In the clamping unit described above, the first clamping mechanism is arranged so that the direction from the larger diameter side to the smaller diameter side of the tapered surface coincides with the first direction, and the second clamping mechanism is arranged so that the direction from the larger diameter side to the smaller diameter side of the tapered surface coincides with the second direction. Thus, it becomes possible to restrict the relative movement of the shaft member in the first direction with respect to the clamping unit, and the relative movement of the shaft member in the second direction with respect to the clamping unit. In addition, for each of the first clamping mechanism and the second clamping mechanism, by moving the rolling elements from the smaller diameter side to the larger diameter side of the tapered surface through the inner cylinder, it becomes possible to allow the relative movement of the shaft member in the first direction with respect to the clamping unit, and the relative movement of the shaft member in the second direction with respect to the clamping unit.

### CITATION LIST

### Patent Literature

Patent Literature 1: Japanese Patent Application Laid-Open Publication No. 2014-66365

### SUMMARY

In the clamping unit as described above, switching from the clamping state to the unclamping state may be performed by using fluid pressure such as air pressure or the like. In this case, it is necessary to attach fluid piping to each clamping unit. If fluid piping is attached to each clamping unit, in cases where a plurality of clamping units are combined to form a profiling device or the like, the fluid piping may interfere with other clamping units, thereby reducing the degree of freedom in the arrangement of the clamping units.

The present invention has been made in view of the above-mentioned circumstances, and an object of the present invention is to provide a clamping unit that can increase the degree of freedom of arrangement when a plurality of clamping units are combined with each other.

A clamping unit according to the present invention comprises:
a case in the form of a substantially rectangular parallelepiped member having a through hole that passes therethrough in a longitudinal direction thereof, with a shaft member being inserted into the through hole;
a clamping mechanism arranged in the through hole, in such a manner that it is in a clamping state in which relative movement in the longitudinal direction between the case and the shaft member is restricted when a pressure in a pressure-acting chamber defined in the case is equal to or less than a predetermined threshold value, and that it is in an unclamping state in which relative movement in the longitudinal direction between the case and the shaft member is allowed when the pressure in the pressure-acting chamber is larger than the predetermined threshold value;
a first opening portion formed in a first outer side surface among a plurality of outer side surfaces of the case;
a second opening portion formed in a second outer side surface different from the first outer side surface among the plurality of outer side surfaces of the case; and
a supply and discharge port defined in the case and extending from the first opening portion to the second opening portion via the pressure-acting chamber.

Here, note that the present invention can also be regarded as a clamping system that is configured by connecting a plurality of the above-mentioned clamping units with each other. The clamping system in that case may, for example, include:
a plurality of the clamping units arranged such that the second opening portion in the second outer side surface of one of adjacent two of the clamping units is opposed to the first opening portion in the first outer side surface of the other of the adjacent two clamping units; and
a pair of plates connected to each other in a state of holding the plurality of clamping units therebetween;
wherein one of the pair of plates, which is arranged at a starting end side in a direction of arrangement, may be configured to have a supply and discharge hole formed at a position corresponding to the first opening portion of the clamping unit arranged at a starting end in the direction of arrangement.

According to the present invention, it is possible to provide a clamping unit capable of increasing the degree of freedom of arrangement in the case where a plurality of clamping units are combined with each other.

### BRIEF DESCRIPTION OF THE DRAWINGS

FIG. 1 is a first perspective view illustrating the appearance of a clamping unit in an embodiment;

FIG. 2 is a second perspective view illustrating the appearance of the clamping unit in the embodiment;

FIG. 3 is a view illustrating a configuration example of a case of the clamping unit in the embodiment;

FIG. 4 is a perspective view of the clamping unit with a part of the case transparent (cut away);

FIG. 5 is a cross-sectional view of the clamping unit in a clamping state in the embodiment, as viewed in a transverse direction;

FIG. 6 is a cross-sectional view of an intermediate cylinder in the embodiment, as viewed in a longitudinal direction;

FIG. 7 is a cross-sectional view of the clamping unit in the embodiment, as viewed in the longitudinal direction;

FIG. 8 is a cross-sectional view of the vicinity of a pressure-acting chamber of the clamping unit in the embodiment, as viewed in the transverse direction;

FIG. 9 is a cross-sectional view of the clamping unit in the unclamping state in the embodiment, as viewed in the transverse direction;

FIG. 10 is a view for explaining an example of a method of using the clamping unit alone in the embodiment;

FIG. 11 is a first illustration for explaining an example in which a clamping system is configured by connecting together a plurality of clamping units in the embodiment;

FIG. 12 is a second illustration for explaining an example in which a clamping system is configured by connecting together a plurality of clamping units in the embodiment;

FIG. 13 is a third illustration for explaining an example in which a clamping system is configured by connecting together a plurality of clamping units in the embodiment;

FIG. 14 is a view illustrating a flow of air in the clamping system in the embodiment; and

FIG. 15 is a view illustrating an example in which a profiling device is configured by using clamping units in the present embodiment.

### DESCRIPTION OF THE EMBODIMENTS

In a clamping unit according to the present invention, when the pressure in a pressure-acting chamber is equal to or less than a predetermined threshold value, a clamping mechanism restricts relative movement between a case and a shaft member in a longitudinal direction of the case (an axial direction of the shaft member) (a clamping state). In addition, when the pressure in the pressure-acting chamber is larger than the predetermined threshold value, the clamping mechanism allows relative movement between the case and the shaft member in the longitudinal direction of the case (an unclamping state). The clamping mechanism may be configured to be able to restrict relative movement between the case and the shaft member in opposite directions in the longitudinal direction of the case, or may be configured to be able to restrict relative movement between the case and the shaft member in one direction in the longitudinal direction of the case.

According to the clamping unit of the present invention, it is possible to use a plurality of clamping units in a connected manner. In cases where a plurality of clamping units according to the invention are connected together to form a clamping system, for example, the plurality of clamping units may be arranged so that a first opening portion in a second outer side surface of one of two adjacent clamping units is opposed to a second opening portion in a first outer side surface of the other adjacent clamping unit, and the plurality of clamping units may be connected together in such a manner as being held by a pair of plates. In that case, one of the pair of plates, which is arranged at a starting end side in a direction of arrangement, may be configured to have a supply and discharge hole formed at a position corresponding to a first opening portion of the clamping unit arranged at a starting end in the direction of arrangement.

When fluid (e.g., air or the like) is supplied to the supply and discharge hole in the plate arranged at the starting end side in the direction of arrangement in the case where the clamping mechanisms of the plurality of clamping units connected as described above are each in the clamping state, the fluid flows into a supply and discharge port in the clamping unit arranged at the starting end in the direction of arrangement through the first opening portion thereof. The fluid having flowed into the supply and discharge port is discharged from the second opening portion via the pressure-acting chamber. The fluid having flowed out of the second opening portion of the clamping unit located at the starting end in the direction of arrangement flows into a supply and discharge port in another clamping unit adjacent to the first-mentioned clamping unit through a first opening portion thereof. Due to the formation of such a fluid flow, the pressures in the pressure-acting chambers of the plurality of clamping units become larger than the predetermined threshold value. As a result, the clamping mechanisms of the plurality of clamping units are each switched from the clamping state to the unclamping state substantially at the same time.

When the supply of the fluid to the supply and discharge hole in the plate arranged at the starting end side in the direction of arrangement is stopped in the case where the plurality of clamping units connected as described above are each in the unclamping state, the fluid in the pressure-acting chamber of the clamping unit arranged at the starting end in the direction of arrangement is discharged from the first opening portion through the supply and discharge port. The fluid discharged from the first opening portion of the clamping unit arranged at the starting end in the direction of arrangement is discharged to the supply and discharge hole in the plate arranged at the starting end side in the direction of arrangement. Accordingly, in the clamping units other than the clamping unit located at the starting end in the direction of arrangement, the fluid in each of their pressure-acting chambers flows to their first opening portion through their supply and discharge port, and is then discharged from the first opening portion to a second opening portion in an adjacent clamping unit. Due to the formation of such a fluid flow, the pressures in the pressure-acting chambers of the plurality of clamping units become equal to or less than the predetermined threshold value. As a result, the clamping mechanisms of the plurality of clamping units are each switched from the unclamping state to the clamping state substantially at the same time.

Here, note that the supply and discharge of fluid in the case of using a plurality of clamping units connected together may be performed not only from the first opening portion of the clamping unit arranged at the starting end in the direction of arrangement but also from the second opening portion of the clamping unit arranged at a terminal end in the direction of arrangement. In that case, the plate located at the terminal end side in the direction of arrangement may have a supply and discharge hole formed at a position corresponding to the second opening portion of the clamping unit arranged at the terminal end in the direction of arrangement. As a result, for example, in cases where the number of clamping units to be connected together increases, it is possible to reduce a time lag among the plurality of clamping units related to the operation of switching between the clamping state and the unclamping state.

According to the present invention, it becomes possible to connect a plurality of clamping units with one another to form a clamping system. In addition, according to the present invention, in cases where a plurality of clamping units are connected together to form a clamping system, it is not necessary to attach fluid piping to each clamping unit. As a result, in cases where a plurality of clamping units are combined to form a profiling device or the like, it is possible to increase the degree of freedom in the arrangement of the clamping units. Further, since it is no longer necessary to connect fluid piping to each of the plurality of clamping units, it becomes possible to reduce the number of parts when a plurality of clamping units are used in combination, and thus it also becomes possible to simplify the work of rearranging the clamping units.

### Embodiment

Hereinafter, a specific embodiment of the present invention will be described based on the accompanying drawings. The dimensions, materials, shapes, relative arrangements, and the like of the components described in the present embodiment are not intended to limit the technical scope of the invention only to them unless otherwise specified.

(Schematic Configuration of Clamping Unit)

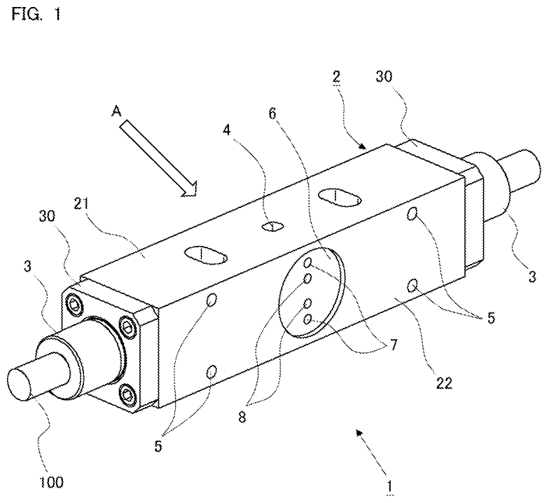

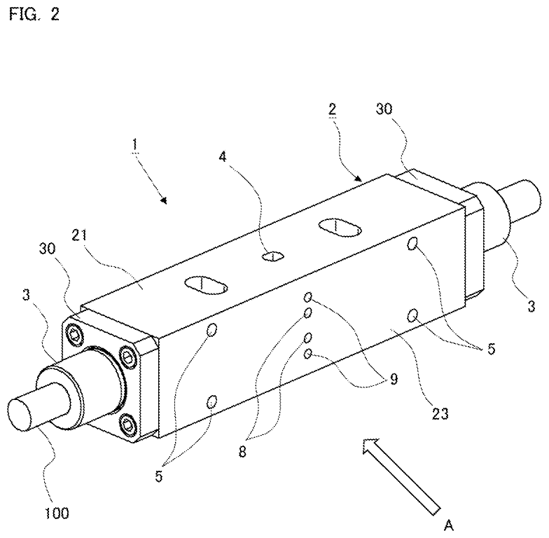

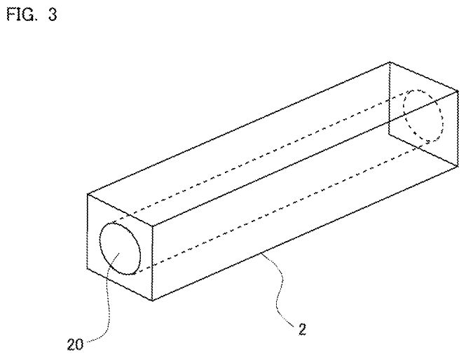

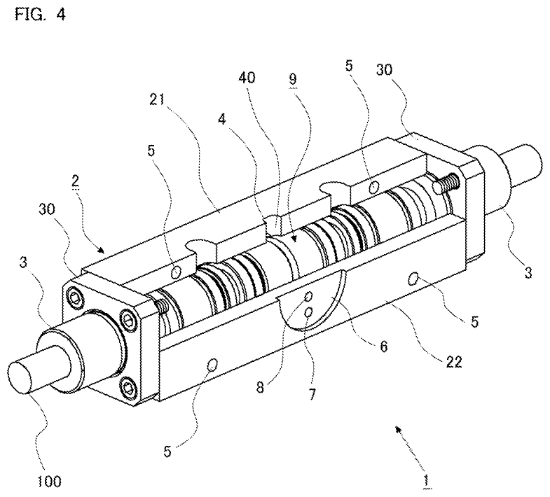

The schematic configuration of a clamping unit 1 in the present embodiment will be described based on FIGS. 1 through 3. FIG. 1 is a first perspective view of the clamping unit 1 in the present embodiment. FIG. 2 is a second perspective view of the clamping unit 1 from the direction of arrow A in FIG. 1. FIG. 3 is a view illustrating the shape of a through hole 20 in a case 2 FIG. 4 is a partially transparent perspective view of the case 2 in FIG. 1.

The clamping unit 1 of the present embodiment includes the case 2 as illustrated in FIGS. 1 through 3. In the example illustrated in FIGS. 1 through 3, the case 2 has a rectangular parallelepiped shape, but it may also have a substantially rectangular parallelepiped shape with a convex or concave end face curved in the longitudinal direction, or a substantially rectangular parallelepiped shape in which, among a plurality of outer side surfaces extending in the longitudinal direction, outer side surfaces other than a first outer side surface 22 and a second outer side surface 23, which will be described later, may each have a substantially rectangular parallelepiped shape curved in a convex or concave shape. As illustrated in FIG. 3, the case 2 is formed with a cylindrical through hole 20 that extends through from one end face to the other end face in the longitudinal direction. As illustrated in FIG. 4, a clamping mechanism 200 is housed in the through hole 20 of the case 2. A shaft member 100 is inserted into the clamping mechanism 200. The clamping mechanism 200 has a function of switching between a clamping state in which the relative movement of the shaft member 100 with respect to the clamping unit 1 is restricted and an unclamping state in which the relative movement of the shaft member 100 with respect to the clamping unit 1 is allowed. In the present embodiment, switching between the clamping state and the unclamping state by the clamping mechanism 200 is performed by air pressure supplied and discharged by an externally installed air pump or the like. Note that details of the clamping mechanism 200 will be described later.

A guide device 3 is attached to each of both end portions of the case 2 in the longitudinal direction. The guide device 3 linearly guides the shaft member 100 inserted into the case 2 along the longitudinal direction thereof. The guide device 3 is, for example, a linear motion bearing including a plurality of rolling elements. The guide device 3 is attached to the case 2, for example, by providing the guide device 3 with a flange 30 having substantially the same shape as a longitudinal end face of the case 2, and fixing the flange 30 to the case 2 by means of bolts or the like. In that case, a spigot structure may be adopted in which a part of the guide device 3 fits into the through hole 20 of the case 2. Thus, the shaft member 100 can be positioned with high accuracy.

The first outer side surface 22 (the outer side surface facing the front in FIGS. 1 and 3), which is one of the four outer side surfaces of the case 2, is formed with a cylindrical concave portion 6 that extends along the transverse direction of the case 2. In the example illustrated in FIGS. 1 and 3, the concave portion 6 is formed at the central portion of the first outer side surface 22, but it may be formed at a position offset from the central portion of the first outer side surface 22.

The concave portion 6 of the first outer side surface 22 is provided with a pair of first opening portions 7 for supplying and discharging air into and from the case 2, and a pair of threaded holes 8. The pair of first opening portions 7 are arranged along the transverse direction of the first outer side surface 22. The pair of threaded holes 8 are arranged between the pair of first opening portions 7 along the transverse direction of the first outer side surface 22. The pair of threaded holes 8 are formed so as to pass through to the through hole 20 in the case 2.

Of the four outer side surfaces of the case 2, the second outer side surface 23 (the outer side surface facing the front in FIG. 2), which is the outer side surface located opposite to the first outer side surface 22, is provided with a pair of second opening portions 9 for supplying and discharging air into the case 2, and a pair of threaded holes 8. The pair of second opening portions 9 are arranged along the transverse direction of the second outer side surface 23. The pair of second opening portions 9 are at the same positions in the longitudinal direction of the case 2 and at the same positions in the transverse direction of the case 2 as the pair of first opening portions 7. The pair of threaded holes 8 are arranged between the pair of second opening portions 9 along the transverse direction of the second outer side surface 23. The pair of threaded holes 8 provided in the second outer side surface 23 are formed so as to pass through to the through hole 20 in the case 2, similarly to the pair of threaded holes 8 provided in the first outer side surface 22.

Of the four outer side surfaces of the case 2, a third outer side surface 21 (an outer side surface facing upward in FIGS. 1, 2 and 4) adjacent to the first outer side surface 22 and the second outer side surface 23 is provided with a third opening portion 4 for supplying and discharging air into the case 2. In the example illustrated in FIGS. 1, 2 and 4, the third opening portion 4 is arranged at the central portion of the third outer side surface 21 (i.e., at a position where the position at which two diagonals in the third outer side surface 21 intersect with each other and the center of the third opening portion 4 coincide with each other), but it may be arranged at a position offset from the central portion of the third outer side surface 21.

The case 2 is provided with a plurality of through holes 5 that pass through the case 2 from the first outer side surface 22 to the second outer side surface 23 along the transverse direction of the case 2. The positions of the through holes 5 are not particularly limited as long as they can avoid the through hole 20, but the through holes 5 may be formed in the vicinity of each of the four corners of the first outer side surface 22 and the second outer side surface 23.

(Configuration of Clamping Mechanism)

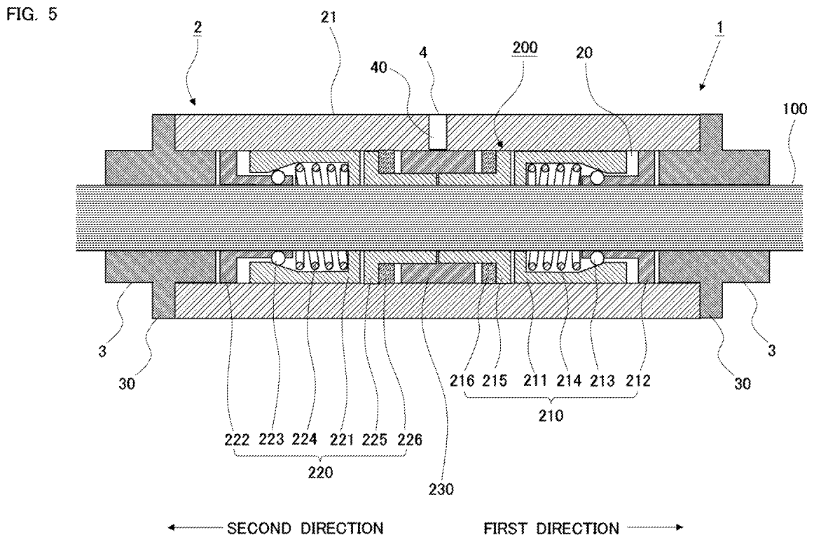

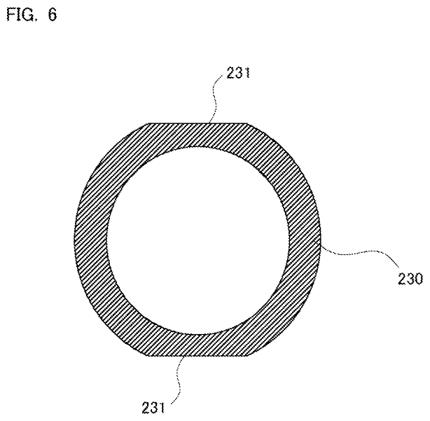

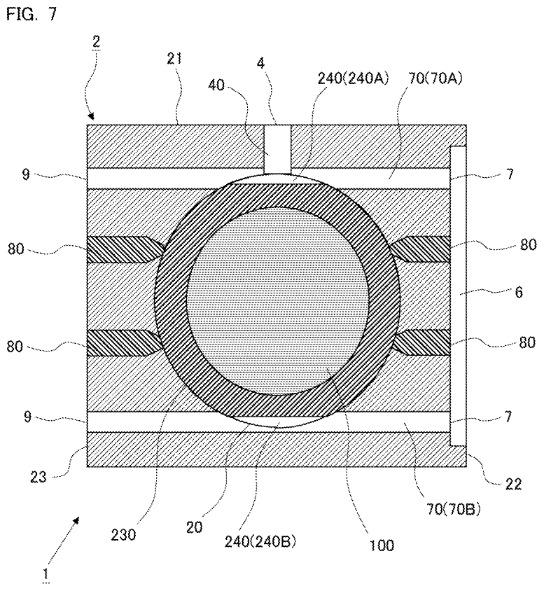

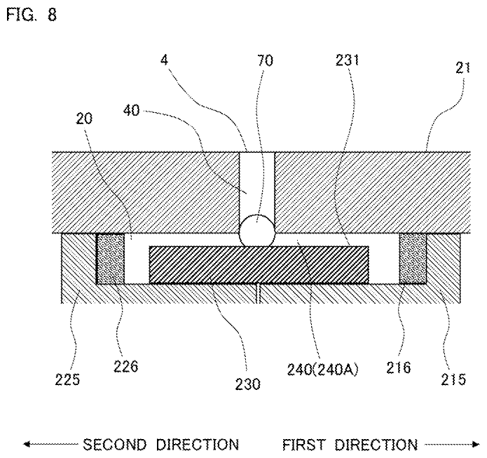

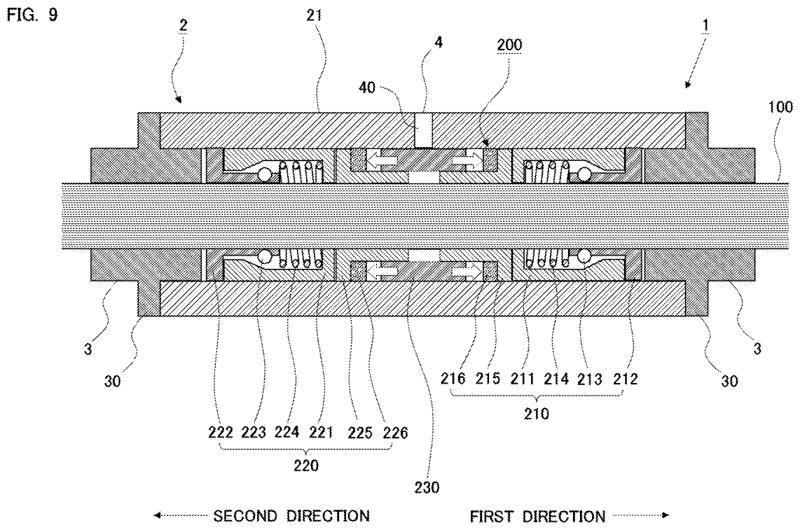

Here, a specific configuration of the clamping mechanism 200 will be described based on FIGS. 5 through 9. FIG. 5 is a cross-sectional view of the clamping unit 1 in its clamping state, as viewed in the transverse direction. FIG. 6 is a cross-sectional view of an intermediate cylinder 230, as viewed in the longitudinal direction. FIG. 7 is a cross-sectional view of the clamping unit 1, as viewed in the longitudinal direction. FIG. 8 is a cross-sectional view of the vicinity of a pressure-acting chamber 240, as viewed in the transverse direction. FIG. 9 is a cross-sectional view of the clamping unit 1 in its unclamping state, as viewed in the transverse direction thereof.

The clamping mechanism 200 in the present embodiment is configured to include a first clamping mechanism 210, a second clamping mechanism 220, the intermediate cylinder 230, and the pressure-acting chamber 240. The first clamping mechanism 210 is a mechanism for restricting the movement of the shaft member 100 in a first direction in the longitudinal direction (a direction from the left side to the right side in FIG. 5). The second clamping mechanism 220 is a mechanism for restricting the movement of the shaft member 100 in a second direction (a direction from the right side to the left side in FIG. 5) opposite to the first direction in the longitudinal direction. The intermediate cylinder 230 is a member that is arranged between the first clamping mechanism 210 and the second clamping mechanism 220.

As illustrated in FIG. 5, the first clamping mechanism 210 is configured to include a first outer cylinder 211, a first inner cylinder 212, a plurality of first rolling elements 213, a first coil spring 214, a first piston 215, and a first packing 216.

The first outer cylinder 211 is a cylindrical member having an outer diameter equal to or slightly smaller than the inner diameter of the through hole 20 and an inner diameter larger than the outer diameter of the shaft member 100. In a portion at the first direction side of the inner peripheral surface of the first outer cylinder 211, there is formed a tapered surface whose inner diameter decreases continuously toward the first direction. Thus, a wedge-shaped space is formed between the tapered surface of the first outer cylinder 211 and the outer peripheral surface of the shaft member 100.

The first inner cylinder 212 is a cylindrical member arranged between the guide device 3 located on the first direction side in the longitudinal direction and the first outer cylinder 211. The first inner cylinder 212 has an inner diameter equal to or slightly larger than the outer diameter of the shaft member 100. The first inner cylinder 212 is formed so as to have an outer diameter smaller than the smallest diameter portion of the tapered surface on the inner peripheral surface of the first outer cylinder 211, and a part thereof is inserted between the first outer cylinder 211 and the shaft member 100. Here, note that an end portion of the first inner cylinder 212 on the first direction side is expanded in diameter so as to have an outer diameter equal to or slightly smaller than the inner diameter of the through hole 20.

A plurality of first rolling elements 213, which roll along the longitudinal direction in a gap between the tapered surface of the first outer cylinder 211 and the outer peripheral surface of the shaft member 100, are held in a portion of the first inner cylinder 212 that is inserted between the first outer cylinder 211 and the shaft member 100. The plurality of first rolling elements 213 are arranged in an annular shape along the circumferential direction of the first inner cylinder 212, and are rotatably held in the first inner cylinder 212. The first rolling elements 213 are, for example, gourd rollers. Here, note that the first rolling elements 213 may be balls.

The first coil spring 214 is housed in the first outer cylinder 211, and presses the first outer cylinder 211 in the second direction with respect to the first inner cylinder 212. The first coil spring 214 is an example of a “first urging member” according to the present invention. Here, note that a component for urging the first outer cylinder 211 in the second direction is not limited to a coil spring, but may be anything that has elasticity.

The first piston 215 is a cylindrical member that is arranged adjacent to the first outer cylinder 211 in the second direction. The first piston 215 has an inner diameter that is equal to or slightly larger than the outer diameter of the shaft member 100. The first piston 215 has an outer diameter smaller than the inner diameter of the through hole 20. However, an end of the first piston 215 on the first direction side is expanded in diameter so as to have an outer diameter that is equal to or slightly smaller than the inner diameter of the through hole 20.

The first packing 216 is an annular member that has an outer diameter equal to or slightly larger than the inner diameter of the through hole 20 and an inner diameter equal to or slightly smaller than the outer diameter of the first piston 215. The first packing 216 is fitted onto the outer peripheral surface of the first piston 215. In that case, the first packing 216 is fitted so that an end thereof on the first direction side is in contact with the enlarged diameter portion of the first piston 215.

Next, as illustrated in FIG. 5, the second clamping mechanism 220 is configured to include a second outer cylinder 221, a second inner cylinder 222, a plurality of second rolling elements 223, a second coil spring 224 (corresponding to a “second urging member” according to the present invention), a second piston 225, and a second packing 226. The second outer cylinder 221, the second inner cylinder 222, the second rolling elements 223, the second coil spring 224, the second piston 225, and the second packing 226 are configured to be the same as the first outer cylinder 211, the first inner cylinder 212, the first rolling elements 213, the first coil spring 214, the first piston 215, and the first packing 216 of the first clamping mechanism 210, respectively. However, the second outer cylinder 221, the second inner cylinder 222, the second rolling elements 223, the second coil spring 224, the second piston 225, and the second packing 226 are arranged in the opposite direction from the first clamping mechanism 210. That is, the second clamping mechanism 220 is arranged in such a direction that the tapered surface of the second outer cylinder 221 becomes continuously smaller toward the second direction.

The intermediate cylinder 230 is a substantially cylindrical member that is arranged in the central portion of the through hole 20 in the longitudinal direction and between the first clamping mechanism 210 and the second clamping mechanism 220. The intermediate cylinder 230 has an outer diameter equal to or slightly smaller than the inner diameter of the through hole 20. The intermediate cylinder 230 has an inner diameter larger than the outer diameter of the shaft member 100. A part of each of the first piston 215 and the second piston 225 is inserted between the inner peripheral surface of the intermediate cylinder 230 and the outer peripheral surface of the shaft member 100 so as to be able to move forward and backward along the longitudinal direction. In this case, the inner diameter of the intermediate cylinder 230, the thickness of the first piston 215 (i.e., the distance in the radial direction from the inner peripheral surface to the outer peripheral surface thereof), and the thickness of the second piston 225 (i.e., the distance in the radial direction from the inner peripheral surface to the outer peripheral surface thereof) are determined such that the distance between the inner peripheral surface of the intermediate cylinder 230 and the outer peripheral surface of the shaft member 100 is equal to or slightly larger than the thickness of each of the first piston 215 and the second piston 225.

Here, note that, in the present embodiment, as illustrated in FIG. 6, a pair of flat portions 231 are provided at two locations on the outer peripheral surface of the intermediate cylinder 230. The pair of flat portions 231 are formed at positions opposite to each other with the central axis of the intermediate cylinder 230 interposed therebetween. In this case, the pair of flat portions 231 are formed so as to be parallel to each other. The intermediate cylinder 230 configured in this manner is fixed to the case 2 in a state where the pair of flat portions 231 are parallel to the third outer side surface 21 of the case 2, as illustrated in FIG. 7. The intermediate cylinder 230 is fixed by means of set screws 80 that are respectively threaded into the two threaded holes 8 in the first outer side surface 22 and the two threaded holes 8 in the second outer side surface 23. Here, note that in the example illustrated in FIG. 7, the intermediate cylinder 230 is fixed by the four set screws 80, but the number of set screws may be three or less, or five or more.

When the intermediate cylinder 230 is fixed to the case 2 as described above, as illustrated in FIGS. 7 and 8, there are formed a pair of pressure-acting chambers 240, which are defined by the inner peripheral surface of the through hole 20, the flat portions 231 of the intermediate cylinder 230, the outer peripheral surface of the first piston 215, the outer peripheral surface of the second piston 225, the end face of the first packing 216 on the second direction side, and the end face of the second packing 226 on the first direction side. Hereinafter, of the pair of pressure-acting chambers 240, the one closer to the third outer side surface 21 will be referred to as a “first pressure-acting chamber 240A”, and the other pressure-acting chamber 240 will be referred to as a “second pressure-acting chamber 240B”. Note that in cases where a common explanation is given for the first pressure-acting chamber 240A and the second pressure-acting chamber 240B, they will be referred to as a pressure-acting chamber 240.

As illustrated in FIGS. 7 and 8, the case 2 is provided with a pair of first supply and discharge ports 70 for placing the pair of first opening portions 7 and the pair of second opening portions 9 in fluid communication with each other. Of the pair of first supply and discharge ports 70, one first supply and discharge port 70 (a first supply and discharge port 70A located on the upper side in FIG. 7) is formed so as to pass through the first pressure-acting chamber 240A. Of the pair of first supply and discharge ports 70, the other first supply and discharge port 70 (a first supply and discharge port 70B located on the lower side in FIG. 7) is formed so as to pass through the second pressure-acting chamber 240B. Also, the case 2 is provided with a second supply and discharge port 40 for placing the third opening portion 4 in the third outer side surface 21 and the first pressure-acting chamber 240A in fluid communication with each other.

In the clamping mechanism 200 configured as described above, when the pressure in each pressure-acting chamber 240 is equal to or less than the urging force of each of the first coil spring 214 and the second coil spring 224, the first clamping mechanism 210 and the second clamping mechanism 220 are each in a clamping state, as illustrated in FIG. 5. That is, in the first clamping mechanism 210, the first outer cylinder 211 is urged in the second direction by the urging force of the first coil spring 214, so that the first rolling elements 213 are pressed from the large-diameter portion side to the small-diameter portion side of the tapered surface of the first outer cylinder 211. Thus, when an external force for moving the shaft member 100 in the first direction is applied, the first rolling elements 213 bite into the wedge-shaped space defined by the tapered surface and the outer peripheral surface of the shaft member 100, thereby restricting relative movement of the shaft member 100 in the first direction with respect to the clamping unit 1. In addition, in the second clamping mechanism 220, the second outer cylinder 221 is urged in the first direction by the urging force of the second coil spring 224, so that the second rolling elements 223 are pressed from the large-diameter portion side to the small-diameter portion side of the tapered surface of the second outer cylinder 221. As a result, when an external force for moving the shaft member 100 in the second direction is applied, the second rolling elements 223 bite into the wedge-shaped space defined by the tapered surface and the outer peripheral surface of the shaft member 100, thereby restricting relative movement of the shaft member 100 in the second direction with respect to the clamping unit 1. Therefore, when the pressure in each pressure-acting chamber 240 is equal to or less than the urging force of each of the first coil spring 214 and the second coil spring 224, the relative movement of the shaft member 100 with respect to the clamping unit 1 is restricted in both the first direction and the second direction.

Moreover, in the clamping mechanism 200 configured as described above, when the pressure in each pressure-acting chamber 240 becomes larger than the urging force of each of the first coil spring 214 and the second coil spring 224, the first clamping mechanism 210 and the second clamping mechanism 220 are each switched from the clamping state to the unclamping state, as illustrated in FIG. 9. In other words, in the first clamping mechanism 210, the first piston 215 is displaced in the first direction under pressure from the pressure-acting chamber 240. Thus, the first piston 215 presses the first outer cylinder 211 in the first direction, which causes the first rolling elements 213 to roll from the small-diameter portion side to the large-diameter portion side of the tapered surface of the first outer cylinder 211. As a result, the first rolling elements 213 will roll out of the wedge-shaped space. Therefore, the shaft member 100 is allowed to move in the first direction relative to the clamping unit 1. Also, in the second clamping mechanism 220, the second piston 225 is displaced in the second direction under pressure from the pressure-acting chamber 240. Thus, the second piston 225 presses the second outer cylinder 221 in the second direction, which causes the second rolling elements 223 to roll from the small-diameter portion side to the large-diameter portion side of the tapered surface of the second outer cylinder 221. As a result, the second rolling elements 223 will roll out of the wedge-shaped space. Therefore, the shaft member 100 is allowed to move in the second direction relative to the clamping unit 1. Therefore, when the pressure in each pressure-acting chamber 240 is larger than the urging force of each of the first coil spring 214 and the second coil spring 224, relative movement of the shaft member 100 with respect to the clamping unit 1 is allowed in both the first direction and the second direction.

Here, note that the clamping mechanism 200 is not limited to having both the first pressure-acting chamber 240A and the second pressure-acting chamber 240B, but may also have only the first pressure-acting chamber 240A.

(Operation and Effects of the Present Embodiment)

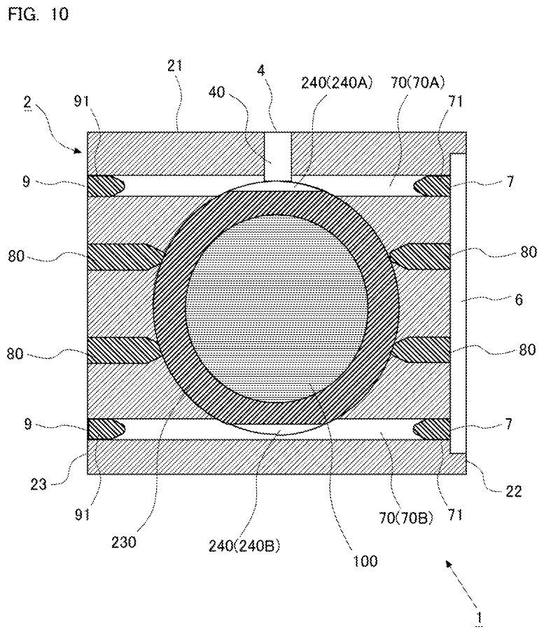

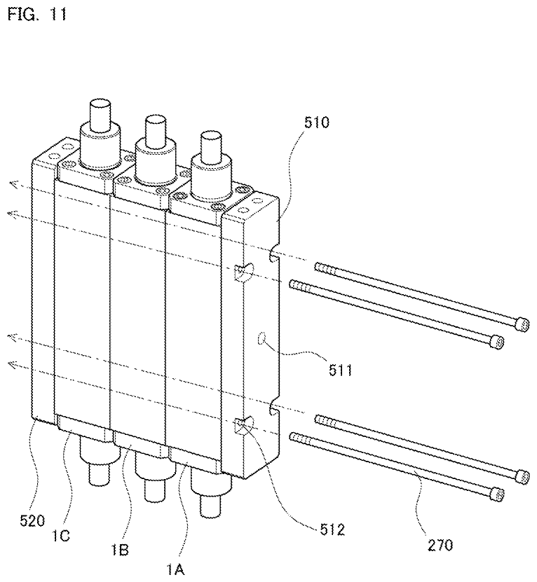

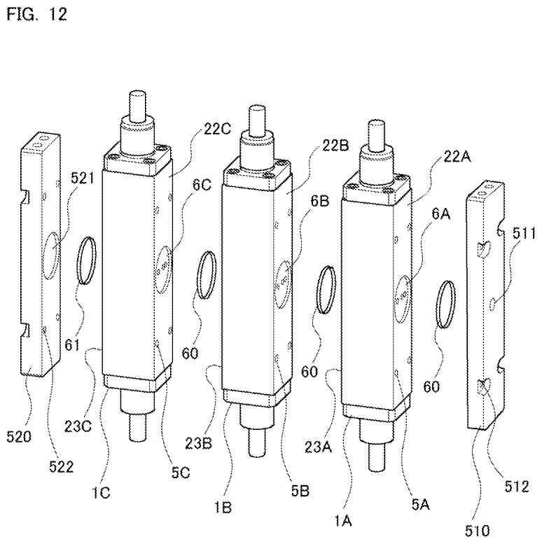

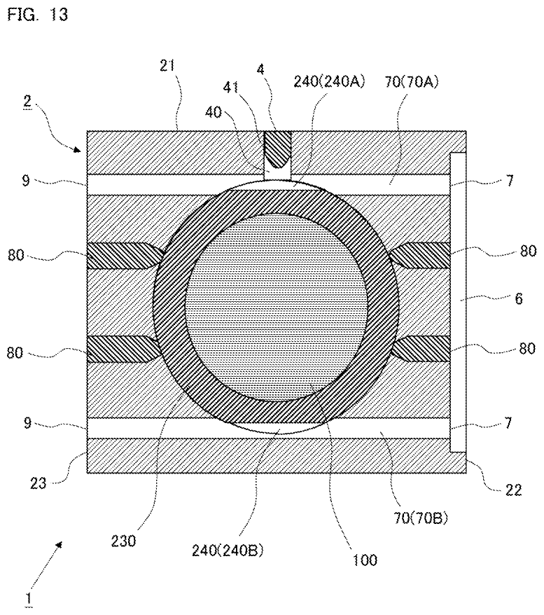

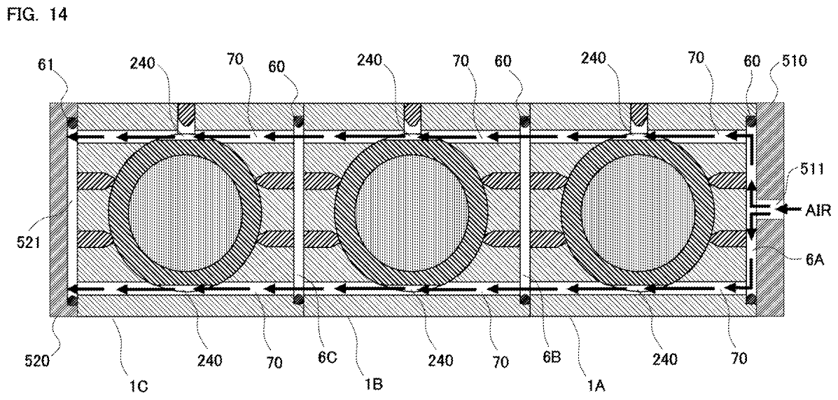

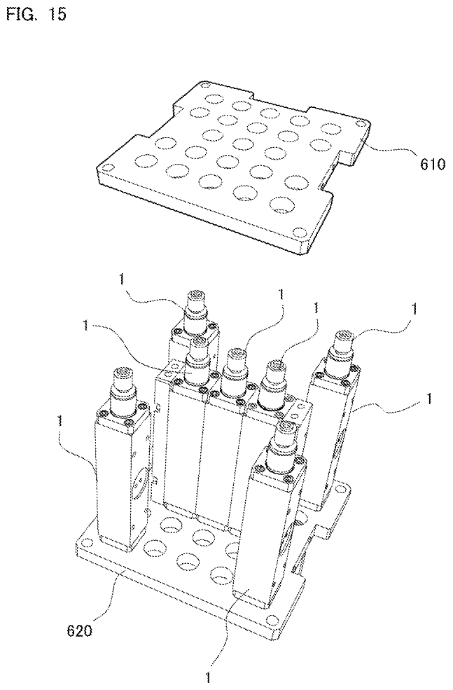

Here, the operation and effects of the present embodiment will be described based on FIGS. 10 through 15. FIG. 10 is a view for explaining a method of using the clamping unit 1 by itself. FIG. 11 is a first illustration for explaining an example of a method of using a plurality of clamping units 1 connected with one another. FIG. 12 is a second illustration for explaining an example of a method of using a plurality of clamping units 1 connected with one another. FIG. 13 is a third illustration for explaining an example of a method of using a plurality of clamping units 1 connected with one another. FIG. 14 is a view illustrating the flow of air in the case of using a plurality of clamping units 1 connected with one another. FIG. 15 is a view illustrating an example of a method of configuring a profiling device by using a plurality of clamping units 1.

First, in the case of using the clamping unit 1 by itself or alone, as illustrated in FIG. 10, the first opening portions 7 in the first outer side surface 22 are sealed by sealing members 71, respectively, and the second opening portions 9 in the second outer side surface 23 are sealed by sealing members 91, respectively. As the sealing members 71, 91, there can be used set screws. In that case, threaded grooves may be formed in the first opening portions 7 and the second opening portions 9. In addition, air piping is adapted to be connected at one end thereof to the third opening 4 in the third outer side surface 21. The air piping is to be connected at the other end thereof to an air pump installed outside, for example.

In the state illustrated in FIG. 10, when air is supplied from the air pump to the third opening portion 4, the supplied air flows from the third opening portion 4 into the first pressure-acting chamber 240A through the second supply and discharge port 40. As a result, the pressure in the first pressure-acting chamber 240A increases to a level larger than the urging force of each of the first coil spring 214 and the second coil spring 224. When the pressure in the first pressure-acting chamber 240A becomes larger than the urging force of each of the first coil spring 214 and the second coil spring 224, the first piston 215 is displaced in the first direction, and the second piston 225 is displaced in the second direction, whereby the first clamping mechanism 210 and the second clamping mechanism 220 are each brought into an unclamping state, as illustrated in the above-mentioned FIG. 9.

When the supply of air from the air pump to the third opening portion 4 is stopped in the case where the first clamping mechanism 210 and the second clamping mechanism 220 are each in the unclamping state, the air in the first pressure-acting chamber 240A is discharged from the third opening portion 4 through the second supply and discharge port 40. As a result, the pressure in the first pressure-acting chamber 240A drops to equal to or less than the urging force of each of the first coil spring 214 and the second coil spring 224. When the pressure in the first pressure-acting chamber 240A becomes equal to or less than the urging force of each of the first coil spring 214 and the second coil spring 224, the first outer cylinder 211 and the first piston 215 are displaced in the second direction by the urging force of the first coil spring 214, and at the same time, the second outer cylinder 221 and the second piston 225 are displaced in the first direction by the urging force of the second coil spring 224. As a result, the first rolling elements 213 roll into the wedge-shaped space between the tapered surface of the first outer cylinder 211 and the outer peripheral surface of the shaft member 100, and the second rolling elements 223 roll into the wedge-shaped space between the tapered surface of the second outer cylinder 221 and the outer peripheral surface of the shaft member 100. As a result, as illustrated in the above-mentioned FIG. 5, the first clamping mechanism 210 and the second clamping mechanism 220 are placed into the clamping state.

Next, an example in which a plurality of clamping units 1 are connected together to form a clamping system will be described based on FIGS. 11 through 14. Here, an example will be described in which three clamping units 1 are connected to form a clamping system. Also, three clamping units 1 are referred to as a first clamping unit 1A, a second clamping unit 1B, and a third clamping unit 1C in the order of connection.

In the case of connecting the first through third clamping units 1A-1C, as illustrated in FIG. 11, the first through third clamping units 1A-1C are held by a pair of plates 510, 520 and fastened by fastening bolts 270. In making such a connection, a packing 60 having an outer diameter substantially equal to the inner diameter of the concave portions 6A-6C and a thickness slightly larger than the depth of the concave portions 6A-6C is fitted into each of the concave portions 6A-6C of the first through third clamping units 1A-1C. Also, as illustrated in FIG. 13, a sealing member 41 is attached to the third opening portion 4 in each of the first through third clamping units 1A-1C. As the sealing member 41, there can be used a set screw. In that case, a threaded groove may be formed in the third opening portion 4 in each of the first through third clamping units 1A-1C.

After attaching the packing 60 and the sealing member 41 to each of the first through third clamping units 1A-1C, the first through third clamping units 1A-1C are arranged so that the second outer side surface 23A of the first clamping unit 1A and the first outer side surface 22B of the second clamping unit 1B come into contact with each other, and the second outer side surface 23B of the second clamping unit 1B and the first outer side surface 22C of the third clamping unit 1C come into contact with each other. A plate 510 is brought into contact with the first outer side surface 22A of the first clamping unit 1A. The plate 510 is formed with one supply and discharge hole 511 and four through holes 512. The supply and discharge hole 511 is a hole that passes through the plate 510, and is formed at a position corresponding to the concave portion 6 of the first clamping unit 1A. The supply and discharge hole 511 is configured to allow connection of air piping from an external air pump. The four through holes 512 in the plate 510 are formed at positions corresponding to the four through holes 5 in the first clamping unit 1A. In addition, a plate 520 is brought into contact with the second outer side surface 23C of the third clamping unit 1C. One surface of the plate 520 (which is in contact with the second outer side surface 23C of the third clamping unit 1C) is provided with a cylindrical concave portion 521. The concave portion 521 is provided at a position corresponding to a pair of second opening portions 9 in the second outer side surface 23C of the third clamping unit 1C. A packing 61 having an outer diameter substantially equal to the inner diameter of the concave portion 521 and a thickness slightly larger than the depth of the concave portion 521 is fitted into the concave portion 521. Also, the plate 520 is provided with four through holes 522. The four through holes 522 are provided at positions corresponding to the four through holes 5 in the third clamping unit 1C.

As described above, in a state where the first through third clamping units 1A-1C and the plates 510, 520 are arranged side by side, the fastening bolts 270 are attached so as to pass sequentially from the through holes 512 in the plate 510 to the through holes 522 in the plate 520 through the through holes 5A-5C in the first through third clamping units 1A-1C. Then, nuts are respectively attached and tightened to the tip ends of the fastening bolts 270. The tightening torque at that time may be determined, for example, in such a manner that the packings 60-61 can exhibit airtightness.

When air is supplied from the supply and discharge hole 511 in the plate 510 in a state where the first through third clamping units 1A-1C are connected with each other, as illustrated in FIG. 14, the supplied air flows from the supply and discharge hole 511 into the concave portion 6A of the first clamping unit 1A. The supplied air having flowed into the concave portion 6A further flows from the first opening portions 7 in the first clamping unit 1A into the first supply and discharge ports 70 thereof without leaking to the outside due to the action of the related packing 60. A part of the supplied air having flowed into the first supply and discharge ports 70 flows into the pressure-acting chamber 240, and the remaining supplied air is discharged from the second opening portions 9.

The supplied air discharged from the second opening portions 9 in the first clamping unit 1A flows into the concave portion 6B of the second clamping unit 1B. The supplied air having flowed into the concave portion 6B further flows from the first opening portions 7 in the second clamping unit 1B into the first supply and discharge ports 70 thereof without leaking to the outside due to the action of the related packing 60. A part of the supplied air having flowed into the first supply and discharge ports 70 flows into the pressure-acting chamber 240, and the remaining supplied air is discharged from the second opening portions 9.

The supplied air discharged from the second opening portions 9 in the second clamping unit 1B flows into the concave portion 6C of the third clamping unit 1C. The supplied air having flowed into the concave portion 6C further flows from the first opening portions 7 in the third clamping unit 1C into the first supply and discharge ports 70 thereof without leaking to the outside due to the action of the related packing 60. The supplied air having flowed into the first supply and discharge ports 70 flows into the pressure-acting chamber 240. At that time, a part of the supplied air having flowed into the first supply and discharge ports 70 flows from the second opening portions 9 into the concave portion 521 in the plate 520, but since the concave portion 521 is sealed by the action of the packing 61, the supplied air flowing into the concave portion 521 is prevented from leaking into the outside.

When the flow of the supplied air is formed as illustrated in FIG. 14, the pressure in the pressure-acting chamber 240 of each of the first through third clamping units 1A-1C can be made larger than the urging force of each of the first coil spring 214 and the second coil spring 224. Thus, the first clamping mechanism 210 and the second clamping mechanism 220 of each of the first through third clamping units 1A—1C can each be switched from the clamping state to the unclamping state, as illustrated in the above-mentioned FIG. 9.

In addition, when the supply of air from the air pump to the supply and discharge hole 511 is stopped in the case where the first clamping mechanism 210 and the second clamping mechanism 220 of each of the first through third clamping units 1A-1C are each in an unclamping state, there is formed a flow in a direction opposite to the flow illustrated in FIG. 14 described above, so that the pressure in the pressure-acting chamber 240 of each of the first through third clamping units 1A-1C drops equal to or less than the urging force of each of the first coil spring 214 and the second coil spring 224. Thus, the first clamping mechanism 210 and the second clamping mechanism 220 of each of the first through third clamping units 1C are each switched to the clamping state as illustrated in FIG. 5 described above.

Here, note that in FIGS. 11 through 14, a method of connecting three clamping units 1 is illustrated, but the same method can be used to connect two or four or more clamping units 1 with each other. In addition, in cases where the number of clamping units 1 to be connected increases, a supply and discharge hole may be formed in the concave portion 521 of the plate 520, so that air can be supplied from both the supply and discharge hole 511 in the plate 510 and the supply and discharge hole in the plate 520.

According to the clamping unit 1 of the embodiment described above, it becomes possible to cope with both the use of a single unit and the use of a plurality of units connected with each other. In addition, in the case of using a plurality of clamping units 1 connected with each other, it is not necessary to connect air piping to each individual clamping unit 1, thus making it difficult for air piping to interfere with surrounding members. As a result, it is possible to increase the degree of freedom of arrangement in the case of using a plurality of clamping units connected with each other. For example, as illustrated in FIG. 15, it is also possible to configure a profiling device by combining some single clamping units 1 and multiple connected clamping units 1. In that case, if positioning of each clamping unit 1 is made by using a pair of plates 610, 620 that have a plurality of holes into which both ends in the longitudinal direction of the clamping units 1 are fitted, it becomes possible to make a rearrangement of the clamping units 1 by removing one plate 610. Further, according to the clamping units 1 in the present embodiment, the clamping units 1 can be directly connected to each other, thus making it possible to narrow the intervals between the shaft members 100 in the profiling device. As a result, it also becomes possible to configure the profiling device that is able to handle a work having a complicated shape.

### OTHER EMBODIMENTS

In the embodiment described above, a clamping unit having both a first clamping mechanism and a second clamping mechanism is illustrated, but only one of the first clamping mechanism and the second clamping mechanism may be provided.

Moreover, in the embodiment described above, an example has been described in which a second outer side surface and a third outer side surface are located on the opposite sides of each other, but the second outer side surface and the third outer side surface may be two outer side surfaces adjacent to each other among the three outer side surfaces other than a first outer side surface. In this case, a second supply and discharge port may be formed so as to be appropriately bent at an appropriate location inside the case.

What is claimed is:

1. A clamping unit comprising:
a case in the form of a substantially rectangular parallelepiped member having a through hole that passes therethrough in a longitudinal direction thereof, with a shaft member being inserted into the through hole;
a clamping mechanism arranged in the through hole, in such a manner that it is in a clamping state in which relative movement in the longitudinal direction between the case and the shaft member is restricted when a pressure in a pressure-acting chamber defined in the case is equal to or less than a predetermined threshold value, and that it is in an unclamping state in which relative movement in the longitudinal direction between the case and the shaft member is allowed when the pressure in the pressure-acting chamber is larger than the predetermined threshold value;
a first opening portion provided in a first outer side surface among a plurality of outer side surfaces of the case;
a second opening portion formed in a second outer side surface different from the first outer side surface among the plurality of outer side surfaces of the case; and
a supply and discharge port defined in the case and extending from the first opening portion to the second opening portion via the pressure-acting chamber.

2. The clamping unit according to claim 1, wherein
a cylindrical concave portion is formed in the first outer side surface of the case so as to extend in a transverse direction of the case; and
the first opening portion is formed in the concave portion.

3. The clamping unit according to claim 2, wherein
the first outer side surface and the second outer side surface are outer side surfaces that are located on opposite sides of each other among the plurality of outer side surfaces of the case.

4. The clamping unit according to claim 3, wherein
the clamping mechanism includes a first clamping mechanism comprising:
a first outer cylinder in the form of a cylindrical member through which the shaft member is inserted, the first outer cylinder being formed with a tapered surface on an inner peripheral surface thereof surrounding an outer peripheral surface of the shaft member, the tapered surface decreasing in diameter toward a first direction in the longitudinal direction;
a first inner cylinder in the form of a cylindrical member through which the shaft member is inserted, a part of the cylindrical member being inserted into a gap between the tapered surface and the outer peripheral surface of the shaft member;
a plurality of first rolling elements held in the first inner cylinder and configured to roll along an axial direction in the gap between the tapered surface and the outer peripheral surface of the shaft member;
a first urging member configured to urge the first outer cylinder with respect to the first inner cylinder in a second direction opposite to the first direction; and
a first piston in the form of a cylindrical member through which the shaft member is inserted, the first piston being arranged in such a manner that one end portion thereof in the longitudinal direction is in contact with an end portion of the first outer cylinder on the second direction side, the first piston being configured to press the first outer cylinder in the first direction when the pressure in the pressure-acting chamber is larger than an urging force of the first urging member.

5. The clamping unit according to claim 4, wherein
the clamping mechanism further includes a second clamping mechanism comprising:
a second outer cylinder in the form of a cylindrical member through which the shaft member is inserted, the second outer cylinder being formed with a tapered surface on an inner peripheral surface thereof surrounding the outer peripheral surface of the shaft member, the tapered surface decreasing in diameter toward the second direction;
a second inner cylinder in the form of a cylindrical member through which the shaft member is inserted, a part of the cylindrical member being inserted into a gap between the tapered surface of the second outer cylinder and the outer peripheral surface of the shaft member;
a plurality of second rolling elements held in the second inner cylinder and configured to roll along an axial direction in the gap between the tapered surface of the second outer cylinder and the outer peripheral surface of the shaft member;
a second urging member configured to urge the second outer cylinder in the first direction with respect to the second inner cylinder; and
a second piston in the form of a cylindrical member through which the shaft member is inserted, the second piston being arranged in such a manner that one end portion thereof in the longitudinal direction is in contact with an end portion of the second outer cylinder on the first direction side, the second piston being configured to press the second outer cylinder in the second direction when the pressure in the pressure-acting chamber is larger than an urging force of the second urging member.

6. The clamping unit according to claim 5, wherein
the first clamping mechanism and the second clamping mechanism are housed in the case so that the first piston and the second piston are adjacent to each other;
the clamping mechanism further comprises an intermediate cylinder in the form of a cylindrical member through which the shaft member is inserted, the intermediate cylinder being fixed to the case in a state in which a part of each of the first piston and the second piston is inserted into a gap between the inner peripheral surface of the cylindrical member and the shaft member; and
the pressure-acting chamber is defined by an outer peripheral surface of the intermediate cylinder, an inner peripheral surface of the case, an outer peripheral surface of the first piston, and an outer peripheral surface of the second piston.

7. A clamping system configured by connecting a plurality of clamping units according to claim 1 connected with each other, the clamping system comprising:
the plurality of the clamping units arranged such that the second opening portion in the second outer side surface of one of adjacent two of the clamping units is opposed to the first opening portion in the first outer side surface of the other of the adjacent two clamping units; and
a pair of plates connected to each other in a state of holding the plurality of clamping units therebetween;
wherein one of the pair of plates, which is arranged at a starting end side in a direction of arrangement, is configured to have a supply and discharge hole formed at a position corresponding to the first opening portion of the clamping unit arranged at a starting end in the direction of arrangement.
